(19) United States
(12) Patent Application Publication
(10) Pub. No.: US 2010/0118274 A1
(43) Pub. Date: May 13, 2010

(54) PROJECTION DISPLAY HAVING DUAL MODE FUNCTION

(76) Inventors: Byeong-Dae Choi, Daegu (KR); Dae-Hwan Kim, Deagu (KR)

Correspondence Address: THE NATH LAW GROUP, 112 South West Street, Alexandria, VA, 22314, US

(21) Appl. No.: 12/449,643

(22) PCT Filed: Feb. 19, 2008
(86) PCT No.: PCT/KR2008/000967

§ 371 Date: Aug. 19, 2009

(30) Foreign Application Priority Data
Feb. 20, 2007 (KR) 10-20074-0016978

(51) Int. Cl. G03B 21/14

(52) U.S. Cl. 353/20

(57) ABSTRACT

A projection display having a dual mode function is provided. The projection display includes: a driving unit controlling an entire operation; a light source unit; a polarization beam splitter splitting light provided from the light source unit into first and second polarized light beams; a first light modulation device located in a path through which the first polarized light beam provided from the PBS (polarization beam splitter), the first light modulation device modulating the first polarized light beam in response to a first image signal and providing the first image; a first projection lens unit magnifying and projecting the first image provided from the first light modulation device; a second light modulation device located in a path through which the second polarized light beam provided from the PBS, the second light modulation device modulating the second polarized light beam in response to a second image signal and providing the second image; and a second projection lens unit magnifying and projecting the second image provided from the second light modulation device.

Accordingly, it is possible for the projection display to display two images by using a light source. Thus, it is possible to embody a small display having a dual mode function with low power consumption which is suitable to be used for a mobile device.

### TECHNICAL FIELD

The present invention relates to a projection display having a dual mode function for concurrently displaying two images, and more specifically, to a projection display with a small size and low power consumption by concurrently displaying two different images by using a light source.

### BACKGROUND ART

Recently, as demands on a large screen and a high quality image for displays have been increased, projection displays which magnify and project a small image by using projection lenses have been rapidly spread. The projection displays are classified into front projection displays and rear projection displays. The front projection displays are mainly used as general conference projectors. The front projection displays are expected to be developed as subminiature projectors. Typical rear projection displays are projection televisions (TVs) shown in FIG. 1. Flat panel displays having a thin and large screen with a low price are spotlighted as the projection TVs.

A liquid crystal device (LCD), a digital micromirror device (DMD), and a reflection type liquid crystal on silicon (LCoS) are widely used as light modulation devices used for the front projection displays and the rear projection displays. The LCoS and the LCD are liquid crystal modulation devices. The LCoS has a reflection type. The LCD has a transmission type or reflection type if necessary. The liquid crystal modulation device displays an image by changing strength of light by changing a rotation angle of incident polarized light in response to an externally applied electrical change and transmitting the light through a polarization plate with a predetermined direction. On the other hand, the DMD is used for a digital light processing (DLP) system. The DMD is an optical switch display for changing a reflection angle of light to two modes by changing an angle of a micromirror to +10 degrees and −10 degrees.

FIG. 1 is a schematic diagram illustrating an inner structure of a rear projection television (RP-TV) using a general light modulation device. Referring to FIG. 1, the projection TV provides light from a light source to a light modulation device such as a DMD, an LCoS, an LCD, and the like, magnifies an image of the light modulation device and forms the image on a screen by using a projection lens system and mirrors. Since the image is magnified and formed on the screen by using a small light modulation device with high image quality, it is possible to easily embody a large screen image. In addition, since the projection system secures high resolution and high luminance as compare with a cathode-ray tube (CRT), the projection system is expected as a large screen display. As described above, various projection displays are provided so as to embody large screens.

On the other hand, recently, as techniques on displays have been developed and as usages of the displays have been diversified, demands on displays capable of concurrently displaying two different images have been increased. However, conventional projection displays provide only a single image.

In addition, recently, various types of multimedia contents have been provided. Most of multimedia reproduction devices or communication devices may be wirelessly driven or used as mobile devices. Accordingly demands on small projection displays with low power consumption having a dual mode function have been increased.

### DISCLOSURE

### Technical Problem

The present invention provides a projection display capable of operating in a dual mode in which two different images are concurrently displayed by using a light source.

The present invention also provides a small projection display having a dual mode function which is driven with low power.

### Technical Solution

According to an aspect of the present invention, there is provided a projection display which operates in a dual mode by providing first and second images by using a single light source unit, the projection display comprising: a driving unit controlling an entire operation; a light source unit; a polarization beam splitter splitting light provided from the light source unit into first and second polarized light beams; a first light modulation device located in a path through which the first polarized light beam provided from the PBS (polarization beam splitter), the first light modulation device modulating the first polarized light beam in response to a first image signal provided by the driving unit and providing the first image; a first projection lens unit magnifying and projecting the first image provided from the first light modulation device; a second light modulation device located in a path through which the second polarized light beam provided from the PBS, the second light modulation device modulating the second polarized light beam in response to a second image signal provided by the driving unit and providing the second image; and a second projection lens unit magnifying and projecting the second image provided from the second light modulation device.

In the above aspect of the present invention, a lamp unit of the light source unit may be constructed with LED arrays constructed with red (R), blue (B), and green (G) LEDs.

In addition, the first and second light modulation devices may be constructed by selectively using transmissive and reflective light modulation devices.

### Advantageous Effects

According to an embodiment of the present invention, it is possible to provide a projection display capable of concurrently displaying two different images. Specifically, it is possible to miniaturize the projection display according to an embodiment of the present invention and to drive the projection display with low power by concurrently displaying two different images by using a light source unit.

In addition, since the projection display according to an embodiment of the present invention basically avoids a polarization loss of a light source, the projection display has a small size and low power consumption. Accordingly, the projection display can be used for mobile devices.

### DESCRIPTION OF DRAWINGS

FIG. 1 is a schematic diagram illustrating an inner structure of a rear projection television (RP-TV) using a general light modulation device.

FIG. 2 is a schematic diagram illustrating an inner structure of a projection display having a dual mode function according to an exemplary embodiment of the present invention.

FIG. 3 is a schematic diagram illustrating a light source unit of a projection display having a dual mode function according to another exemplary embodiment of the present invention.

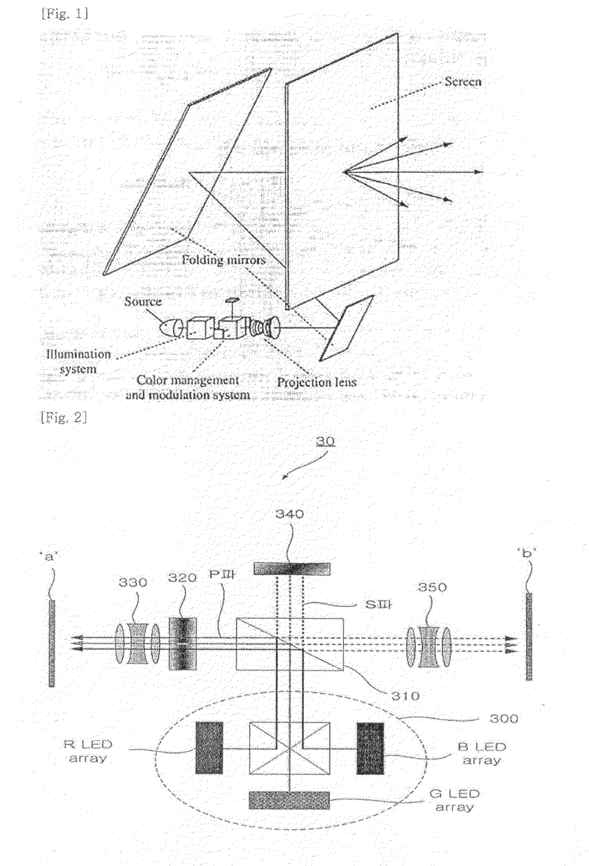

### BEST MODE

Hereinafter, a structure and an operation of a projection display having a dual mode function according to an exemplary embodiment of the present invention will be described in detail with reference to the accompanying drawings.

FIG. 2 is a schematic diagram illustrating an inner structure of a projection display having a dual mode function according to an exemplary embodiment of the present invention. Referring to FIG. 2, a projection display 30 includes a light source unit 300, a polarization beam splitter (PBS) 310, a first light modulation device 320, a first projection lens unit 330, a second light modulation device 340, a second projection lens unit 350, and a driving unit (not shown).

The driving unit controls an entire operation of the projection display 30. The driving unit controls operations of the light source unit 300, and the first and second light modulation devices 320 and 340. Specifically, in order to display two different images, the driving unit provides first and second image signals corresponding to first and second images to the first and second light modulation devices 320 and 340, respectively.

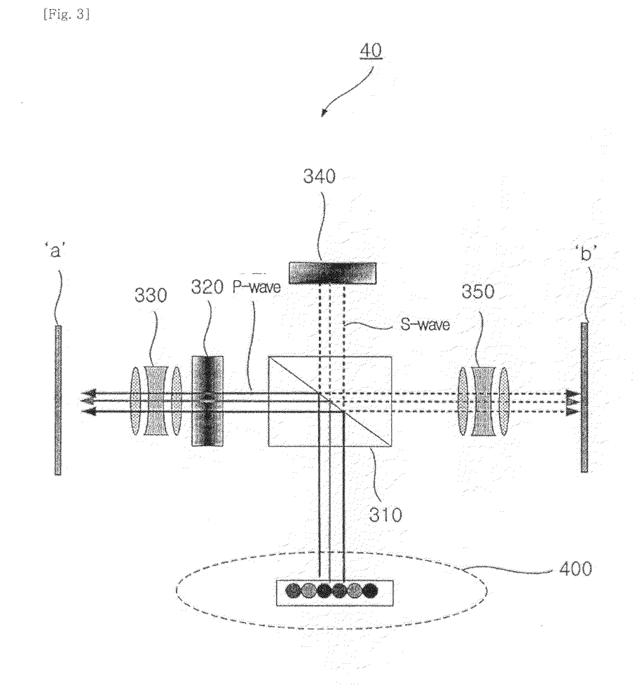

The light source unit 300 is constructed with a lamp unit, an optical system for uniformizing light such as a fly’ eye lens, and the like. The lamp unit may be constructed with a laser or LEDs. For example, the lamp unit is constructed with three plates respectively constructed with blue, green, red LED arrays in which red (R), green (G), and blue (B) LED modules are separated from one another. The LED arrays are sequentially driven according to a frequency of 180 Hz so as to sequentially provide light beams with R, G, and B colors. On the other hand, a lamp unit of a light source unit 300 according to another embodiment of the present invention is constructed with two plates in which red LEDs and blue LEDs are sequentially arranged in a module to construct a LED array, and green LEDs are sequentially arranged to construct a LED array or one plate in which red, green and blue LEDs are sequentially arranged to construct a LED array. FIG. 3 is a schematic diagram illustrating a case where a one-plate type light source 400 in which red, green, and blue LEDs are sequentially arranged to construct a LED array is used. In addition, the lamp unit of the light source unit 110 according to the embodiment may be constructed with an OLED, LD, and the like, in addition to the LED array, or constructed with a point light source or a surface light source.

Since the light source unit is known to those skilled in the art, detailed description on the light source unit will be omitted throughout the specification.

The PBS 310 provides first and second polarized light beams along different light paths by splitting light provided from the light source unit into two orthogonal light beams which are first and second polarized light beams (for example, P-wave and S-wave).

It is known that light is a wave. A wave is constructed with two orthogonal wave components which are a P-wave and an S-wave. The P-wave is a longitudinal wave of which a propagation direction is the same as an oscillation direction of a medium. The S-wave is a transverse wave of which a propagation direction is perpendicular to an oscillation direction of a medium. Since terms of the P-wave and the S-wave are known to those skilled in the art, detailed description on the terms will be omitted.

A path of the P-wave of light provided from the light source unit is changed by passing through the PBS 310, thereby proceeding along a direction perpendicular to the propagation direction. A path of the S-wave of light provided by the light source unit is maintained by passing through the PBS 310, thereby proceeding along a direction that is the same as the propagation direction.

The first light modulation device 320 is located in a path through which the P-wave that is the first polarized wave provided from the PBS 310 proceeds so as to provide a first image by modulating the first polarized wave in response to a first image signal provided by the driving unit. The first light modulation device 320 may use a transmissive light modulation device. The transmissive light modulation device may be a transmissive high-temperature polysilicon liquid crystal display (HTPS-LCD) micro display device.

The first projection lens unit 330 is located in front of the first light modulation device to magnify and project the first image provided from the first light modulation device.

The second light modulation device 340 is located in the path through which the S-wave that is the second polarized wave provided from the PBS 310 proceeds so as to provide a second image by modulating the second polarized wave according to a second image signal provided by the driving unit. The second light modulation device 340 may use a reflective light modulation device. An LCoS, reflective LCD, or DMD device may be selectively used as the reflective light modulation device.

In a case where the second light modulation device is a reflective LCoS light modulation device, the second projection lens unit 350 is located in a path through which light reflected from the second light modulation device and reflected from the PBS is output so as to magnify and project the second image provided from the second light modulation device.

On the other hand, in a case where the second light modulation device is a reflective DMD light modulation device, it is possible to provide a predetermined image at a desired position by adjusting an angle of a location of the second light modulation device and positioning a second projection lens unit in a path of light.

As shown in FIG. 2, different images are formed on screens (‘a’ and ‘b’) which are located at different positions by constructing the first light modulation device with the transmissive light modulation device and constructing the second light modulation device with a reflective light modulation device.

In another embodiment of the present invention, both of the first and second light modulation devices may be constructed with transmissive light modulation devices or reflective light modulation devices.

The projection display having the aforementioned structure operates in a dual mode by concurrently providing different first and second images at different positions by using a single light source unit.

While the present invention has been particularly shown and described with reference to exemplary embodiments thereof, it will be understood by those skilled in the art that various changes in form and details may be made therein without departing from the spirit and scope of the present invention as defined by the appended claims. For example, in an embodiment of the present invention, the first and second light modulation devices, the light source unit, and the like may be changed and used in various manners so as to improve the entire performance of the projection display. All differences within the scope will be construed as being included in the present invention as defined by the appended claims.

### INDUSTRIAL APPLICABILITY

A technique according to an embodiment of the present invention may be widely used for a mobile communication terminal or mobile personal information terminal such as a PMP or PDA.

1. A projection display which operates in a dual mode by providing first and second images by using a single light source unit, the projection display comprising:
a driving unit controlling an entire operation;
a light source unit;
a polarization beam splitter splitting light provided from the light source unit into first and second polarized light beams;
a first light modulation device located in a path through which the first polarized light beam provided from the PBS (polarization beam splitter) proceeds, the first light modulation device modulating the first polarized light beam in response to a first image signal provided by the driving unit and providing the first image;
a first projection lens unit magnifying and projecting the first image provided from the first light modulation device;
a second light modulation device located in a path through which the second polarized light beam provided from the PBS proceeds, the second light modulation device modulating the second polarized light beam in response to a second image signal provided by the driving unit and providing the second image; and
a second projection lens unit magnifying and projecting the second image provided from the second light modulation device.

2. The projection display of claim 1, wherein a lamp unit of the light source unit is constructed with LED arrays constructed with red (R), blue (B), and green (G) LEDs.

3. The projection display of claim 1, wherein the first and second light modulation devices are transmissive light modulation devices.

4. The projection display of claim 1, wherein the first and second light modulation devices are reflective light modulation devices.

5. The projection display of claim 1, wherein the first light modulation device is a transmissive device, and the second light modulation device is a reflective light modulation device.
